(19) United States
(12) Patent Application Publication
(10) Pub. No.: US 2011/0229624 A1
(43) Pub. Date: Sep. 22, 2011

(54) PROCESS AND PRODUCT

(76) Inventors: Philippe Troplin, Louviers (FR); Christophe Leclerc, Elbeuf Sur Seine (FR)

(21) Appl. No.: 13/060,968

(22) PCT Filed: Aug. 25, 2009
(86) PCT No.: PCT/EP09/06154

§ 371 Date: Jun. 7, 2011

(30) Foreign Application Priority Data
Aug. 27, 2008 (GB) 0815534.3

(51) Int. Cl. A23G 1/32; A23G 1/50

(52) U.S. Cl. 426/631

(57) ABSTRACT

A process for producing an inclusion comprising extruding a mixture of at least 20% sugar with at least 25% cocoa powder or at least 10% cocoa cake or at least 10% of a combination of cocoa powder and cocoa cake. An inclusion obtainable by this process. An extruded inclusion comprising at least 20% sugar with at least 25% cocoa powder or at least 10% cocoa cake or at least 10% of a combination of cocoa powder and cocoa cake.

This invention relates to a process for producing an extruded inclusion and to an inclusion thereby produced.

Many processes are known for producing cocoa containing products. Processes for producing such cocoa containing products typically involve dispersing finely ground powders in different matrices, such as for example, fat, milk, flour, water and sugar The finely ground powders may include, for example, cocoa solids, sugar and optionally milk solids. The ingredients that are used are dictated by the nature of the product.

Existing chocolate inclusions can be used in a variety of ways, for example by being included in other foodstuffs. Such chocolate inclusions have been used by adding solid discrete chocolate into a variety of other foodstuffs, such as bakery goods. These have taken the form of products such as chocolate drops or chunks. However, such products suffer from a number of disadvantages. For example, chocolate inclusions necessarily have a relatively high level of fat. Also, many prior art chocolate inclusions are not stable to heat, and are therefore not useful in applications involving the application of heat, such as in cooked bakery products.

There remains a need for bake-stable, or heat resistant, inclusions which have a reduced fat content and for processes which can provide such inclusions.

According to the invention, there is provided a process for producing an inclusion comprising extruding a mixture of at least 20% sugar with at least 25% cocoa powder or at least 10% cocoa cake or at least 10% of a combination of cocoa powder and cocoa cake.

Preferably, the mixture contains less than about 13% fat.

Conveniently, the mixture contains less than about 10% fat.

Advantageously, the mixture contains less than about 6% fat

Preferably, the sugar is icing sugar.

Conveniently, the cocoa powder and/or cocoa cake contains natural cocoa solids.

Advantageously, the cocoa powder and/or cocoa cake contains alkalized cocoa solids.

Preferably, the mixture comprises at least 35% cocoa powder, at least 40% cocoa powder, more preferably at least 50% cocoa powder, more preferably at least 60% cocoa powder.

Conveniently, the mixture comprises at least 20% cocoa cake, more preferably at least 35% cocoa cake, more preferably at least 50% cocoa cake more preferably at least 60% cocoa cake.

Advantageously, the cocoa powder and/or cocoa cake contains from about 0% to about 56% fat.

Preferably, the cocoa powder and/or cocoa cake contains about 21% fat

Conveniently, the cocoa powder and/or cocoa cake contains about 11% fat.

Advantageously, water is added to the mixture before the product is extruded

Preferably, the amount of water added is about 2.5% of the total weight of the mixture.

Conveniently, the mixture is subjected to a pre-conditioning step prior to extrusion.

Advantageously, the pre-conditioning step comprises agitating and/or heating the mixture.

Preferably, the pre-conditioning step comprises heating the mixture to a temperature of from about 30 to about 95° C.

Conveniently, the pre-conditioning step comprises heating the mixture to about 90° C.

Advantageously, the mixture is agitated by kneading.

Preferably, the pre-conditioning step comprises agitating and/or heating the mixture for up to about 300 seconds.

Conveniently, the preconditioning step comprises agitating and/or heating the mixture for about 220 seconds.

Advantageously, additional components are added to the mixture during the pre-conditioning step.

Preferably, the extrusion is performed using a twin screw extruder.

Conveniently, the extrusion is performed using a multi-section extruder.

Advantageously, the temperature of the mixture in the extruder is from about 10° to about 250° C.

Preferably, the temperature of the mixture in the extruder is about 140° C.

Conveniently, the extrusion is performed in a screw extruder with a screw speed of from about 100 to 620 rpm.

Advantageously, the screw speed is about 500 rpm.

Preferably, the extruded product is formed into shaped products after extrusion.

Conveniently, the extruded product is subjected to a drying step.

Advantageously, the extruded product contains less than about 5% water.

Preferably, the mixture also contains at least one further component selected from the group consisting of milk powder, cocoa butter, non-cocoa butter fats, emulsifiers, flavourings and colouring agents.

Conveniently, the mixture consists essentially of sugar and water with cocoa powder and/or cocoa cake.

Advantageously, the mixture consists essentially of sugar with cocoa powder and/or cocoa cake.

Preferably, the process further comprises an additional step of incorporating the inclusion into another food product.

Conveniently, the other food product is a beverage, breakfast cereal, ice cream, dairy product, baked product, dessert, cereal bars, animal food, confectionary or spreadable food product.

According to another aspect of the invention, there is provided an inclusion obtainable by a process of the invention.

According to a further aspect of the invention, there is provided an extruded inclusion comprising at least 20% sugar with at least 25% cocoa powder or at least 10% cocoa cake or at least 10% of a combination of cocoa powder and cocoa cake.

Preferably, the inclusion contains less than about 13% fat.

Conveniently, the inclusion contains less than about 10% fat.

Advantageously, the inclusion contains less than about 6% fat.

Preferably, the sugar is icing sugar.

Conveniently, the cocoa powder and/or cocoa cake contains natural cocoa solids.

Advantageously, the cocoa powder and/or cocoa cake contains alkalized cocoa solids.

Preferably, the inclusion comprises at least 35% cocoa powder, preferably at least 40% cocoa powder, more preferably at least 50% cocoa powder, more preferably at least 60% cocoa powder.

Conveniently, the inclusion comprises at least 20% cocoa cake, more preferably at least 35% cocoa cake, more preferably at least 40% cocoa cake, more preferably at least 50% cocoa cake, more preferably at least 60% cocoa cake.

Advantageously, the cocoa powder and/or cocoa cake contains from about 0% to about 56% fat.

Preferably, the cocoa powder and/or cocoa cake contains about 21% fat.

Conveniently, the cocoa powder and/or cocoa cake contains about 11% fat.

Advantageously, the inclusion contains less than about 5% water.

Preferably, the inclusion further comprises at least one component selected from the ground consisting of milk powder, cocoa butter, non-cocoa butter fats, emulsifiers, flavourings and colouring agents

Conveniently, the inclusion consists essentially of sugar with cocoa powder and/or cocoa cake.

According to another aspect of the invention, there is provided a food product comprising an inclusion of the invention.

Preferably, the food product is selected from the group consisting of beverages, breakfast cereals, ice cream, dairy products, baked products, desserts, cereal bars, animal foods, confectionary and spreadable food products.

The present invention will now be described, by way of example, with reference to the accompany figure in which:

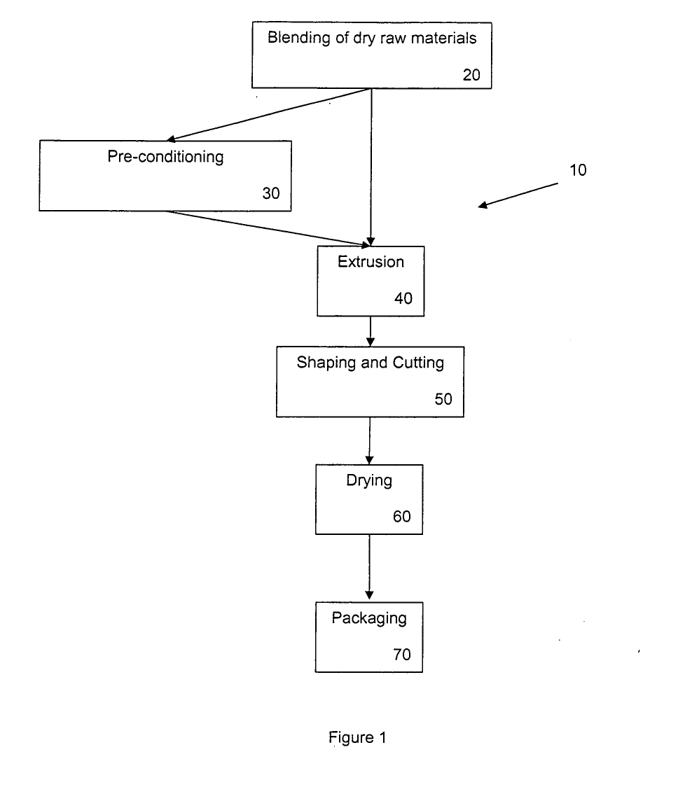

FIG. 1 is a flow-chart illustrating a method for producing a chocolate or cocoa shaped product in accordance with the invention;

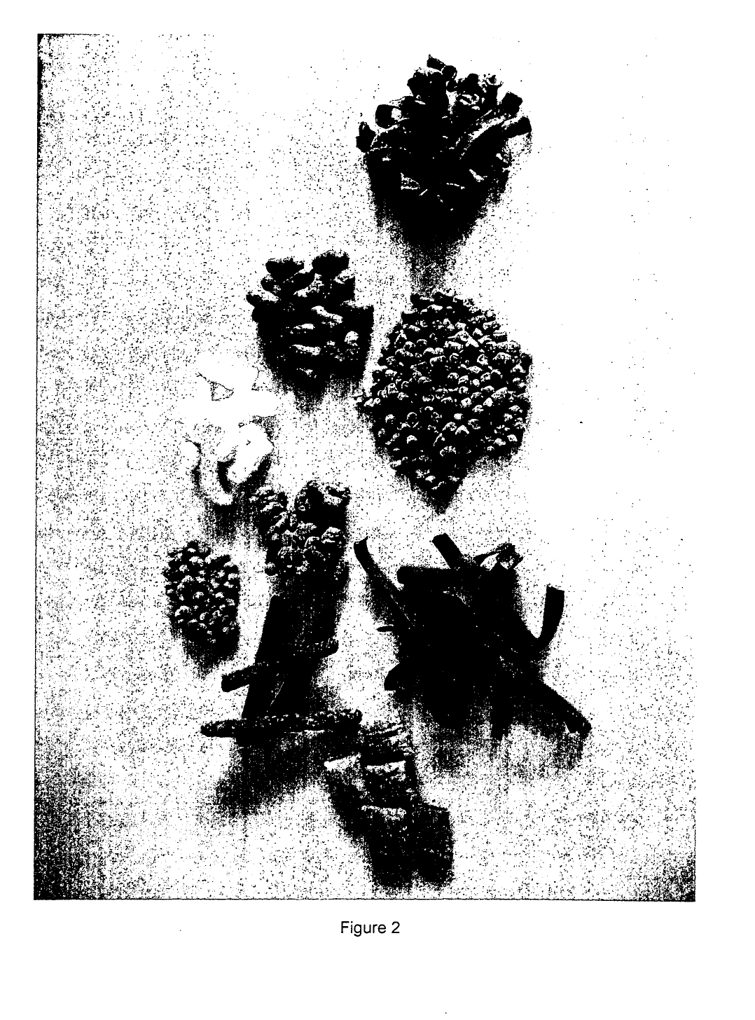

FIG. 2 is a photograph of extruded inclusions of the invention;

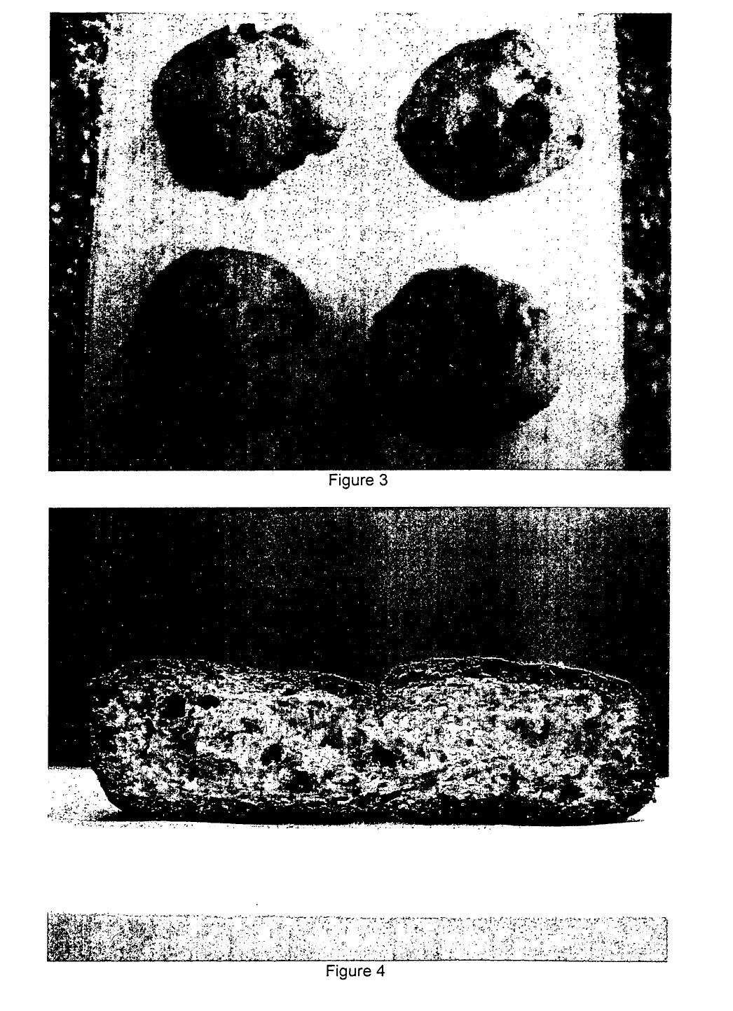

FIG. 3 is a photograph of biscuits containing extruded inclusions of the invention;

FIG. 4 is a photograph of brioche containing extruded inclusions of the invention;

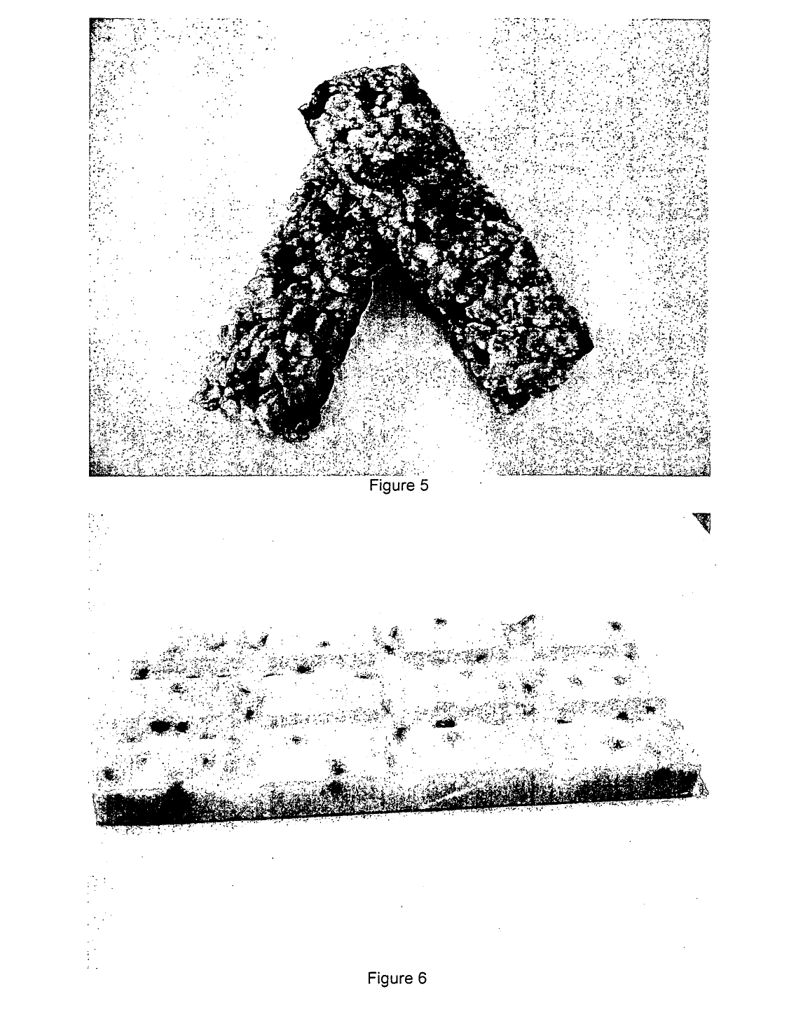

FIG. 5 is a photograph of cereal bars containing extruded inclusions of the invention;

FIG. 6 is a photograph of a bar of chocolate containing extruded inclusions of the invention;

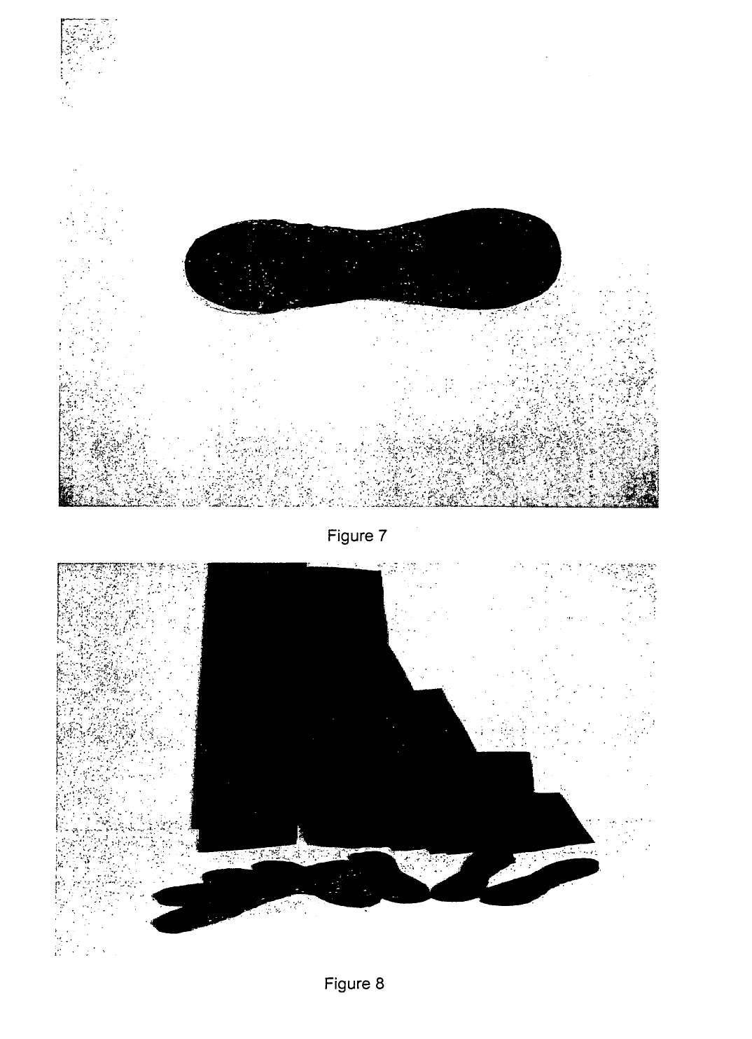

FIG. 7 is a photograph of a spoon formed from extruded inclusion of the invention used as an edible product in its own right;

FIG. 8 is a photograph of spoons formed from extruded inclusion of the invention together with the ribbons from which they may be produced; and

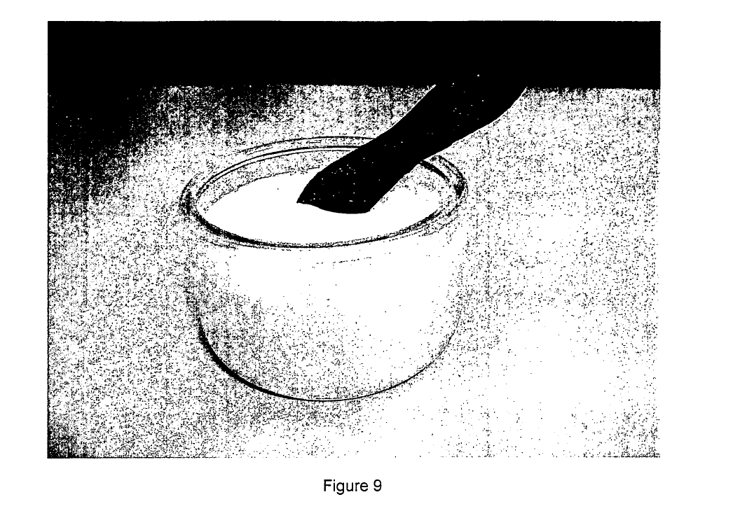

FIG. 9 is a photograph of a spoon formed from extruded inclusion of the invention being used to eat a dessert.

The process of the invention makes it possible to produce a low fat cocoa inclusion. Above that, it has the advantage of avoiding the need for a conching step, a tempering step, a moulding step and/or a cooling step.

Typically, the components used in the production of chocolate include cocoa solids, sugars, sugar substitutes, milk powders, cocoa butter, fat and mixtures thereof. Preferably, the cocoa solids are selected from cocoa powders, expeller flake and mixtures thereof. Milk powders include, for example, skimmed milk powder, whey powder and derivatives thereof, full cream milk powder and mixtures thereof. Suitable sugars include sucrose, fructose, glucose and dextrose and mixtures thereof. Sugar substitutes preferably include inulin, dextrin, isomaltulose, polydextrose and maltitol and mixtures thereof.

Preferably, one or more components selected from emulsifiers and flavouring agents are added during the mixing of the components according to the invention.

The emulsifiers that are preferably added are selected from the group consisting of lecithin, fractionated lecithin, ammonium phosphatide and PGPR or mixtures thereof. Flavouring agents that may be added are preferably selected from the group consisting of vanilla and caramel or mixtures thereof.

The milk powder that may be used in the invention may comprise full cream milk powder, processed or partially-processed milk powder such as skimmed milk powder, whey powder and derivatives thereof, milk protein concentrate, lactose, modified milk powder and mixtures thereof demineralised milk powder is preferred.

The invention also provides cocoa-containing inclusions that can, at least in some countries, be labelled as chocolate flake. For chocolate flake, the fat content can be the minimum as allowed by legislation (e.g. in the EU the minimum fat for chocolate flake is 12%-directive 2000/36). More preferably the process of the invention is particularly suitable for the production of inclusions having a low fat content.

In a preferred embodiment, the inclusion may be a cocoa inclusion or be a chocolate flake inclusion. For example, the combination of cocoa powder (non-defatted) and sugar can produce a chocolate flake inclusion. To illustrate this, if an inclusion comprises a non-defatted cocoa powder in an amount of at least 60% wt., based on the total amount of the inclusion, and the fat content of the cocoa powder is at least 21% by weight based on the weight of the cocoa powder, then the fat content of the inclusion (for example, comprising sugar in an amount of at most 40% wt.) will be at least 12.6% wt.

The inclusion as defined above may be in the form of, for example, sticks, pillows, flakes, curls, granules, pellets, and nuggets

The inclusions may have a fat content of less than about 13% by weight, preferably less than about 10%, more preferably less than about 6%. The products preferably have a fat content of from 1 to 12% by weight, more preferably from 2 to 6% by weight.

A preferred inclusion according to the invention comprises:
about 25% by weight cocoa powder and/or cocoa cake
about 30% by weight milk powder
about 45% by weight sugar

Another preferred inclusion according to the invention comprises
about 50% by weight cocoa powder and/or cocoa cake
about 50% by weight sugar

The percentages of the components, together with any other components present, will add up to 100% by weight of the extruded product.

The sugar preferably comprises sucrose. The total sugar content may be derived from, for example, sugar mixed with the other components and from any sugar present in the other components e.g. any cocoa based materials. In the invention, the amount of sugar referred to relative to the amount of cocoa powder and/or cocoa cake is in addition to any sugar that may form part of the cocoa powder and/or cocoa cake. For example, an inclusion that comprises 50% sugar and 50% cocoa powder may be formed by the addition of 50% sugar and 50% cocoa powder, irrespective of any sugar naturally present in the cocoa powder itself.

The inclusion preferably comprises milk solids. The total milk solids may be derived, for example, for any added milk solids and from any milk solids present in the other components e.g., cocoa based materials, such as chocolate powder. Preferably, the inclusion comprises from 1 to 40% by weight total milk solids, more preferably from 10 to 30% by weight total milk solids, such as from 18 to 28% by weight total milk solids. The added milk solids are typically selected from skimmed milk powder, whey powder and derivatives thereof, full cream milk powder (whole milk powder) and mixtures thereof.

In a particularly preferred embodiment, the inclusion comprises from 1 to 25% by weight (more preferably from 10 to 20% by weight) full cream milk powder and from 1 to 15% (more preferably from 3 to 13% by weight) of skimmed milk powder.

Preferably, the water content of the cocoa inclusion or chocolate flake inclusion is less than about 5% by weight, more preferably from about 1.0 to about 3.0% by weight.

It is preferred that less than 25% of an aqueous liquid (such as milk) is added to the mixture to form the inclusions, more preferably less than 15% and most preferably less than 10%.

Preferably, the inclusion comprises an emulsifier. For example, emulsifiers are generally present in the inclusion in amounts of up to 1% by weight, more preferably up to 0.7% by weight or up to 0.2% by weight, based on the weight of the inclusion respectively.

Emulsifiers include lecithin derived from soya bean, safflower, corn; fractionated lecithins enriched with either phosphatidyl choline, phosphatidyl ethanolamine, phosphatidyl inositol; emulsifiers derived from oats, mono- and diglycerides and their tartaric esters, monosodium phosphate derivatives of mono- and diglycerides of edible fats and oils, sorbitan monostearate, sorbitan tristearate, sucrose esters, polyoxyethylene sorbitan monostearate, hydroxylated lecithin, synthetic phospholipids such as ammonium phosphatides, lactylated fatty acid esters of glycerol and propylene glycol, polyglycerol esters of fatty acids, propylene glycol mono- and diesters of fats and fatty acids. It is preferred to use at least one of fractionated lecithin, polyglycerol polyricinoleate (PGPR), polyglycerol ester, sorbitan tristearate and mixtures thereof.

In this specification, cocoa powder and cocoa cake are disclosed as suitable components for use in their production of the extruded inclusion. These terms have the following meanings. In the production of cocoa products, cocoa beans or seeds are harvested, fermented (partly or fully), dried and the shells removed to extract the inner part of the beans (nibs). The nibs may be ground to a semi-liquid state called cocoa liquor. The cocoa liquor may then be processed to remove a portion of the cocoa butter, which is typically performed in a hydraulic press. The cocoa liquor is effectively sieved under pressure to remove cocoa butter, leaving behind cocoa solids and a proportion of cocoa butter. The compressed mass left behind after this compressive defatting is called cocoa cake. Cocoa butter may also be removed from cocoa liquor by an expeller, which generally compresses the cocoa butter from the cocoa liquor in a continuous manner. The solid cocoa product produced by this process is called expeller flake. In this specification, the term “cocoa cake” is preferably meant to encompass expeller flake.

The cocoa cake may then be further processed by pulverizing and/or grinding to produce cocoa powder. In general, the particles of cocoa powder are smaller than the particles of cocoa cake. It is preferred that the cocoa powder is not micromilled cocoa powder. Preferably, at least 99.5% of the particles of cocoa powder are less than 75 microns in size (methodology OICC 38). It is preferred that a significant proportion of the cocoa powder has a particle size above 20 microns.

The cocoa powder and/or cocoa cake is preferably natural. Alternatively, alkalized cocoa powder and/or cocoa cake is used. Also, the use of defatted cocoa powder and/or cocoa cake is preferred.

The invention can use cocoa powder and cocoa cake having the fat content of from 20 to 22% fat (non-defatted cocoa powder or cocoa cake). Preferably, the cocoa powder or cocoa cake is defatted and contains from about 10 to about 12% fat. Cocoa powder and/or cocoa cake with a lower level of fat may be used, for example below 1% fat, using alternative methods such as the use of supercritical carbon dioxide extraction. In general terms, a defatted cocoa powder or cocoa cake has below about 18% fat.

As mentioned above, the inclusions of the invention can contain at least 25% cocoa powder. More preferably, the inclusions comprise at least 30% cocoa powder, at least 35% cocoa powder, at least 40% cocoa powder, at least 45% cocoa powder, at least 50% cocoa powder, at least 55% cocoa powder and more preferably at least 60% cocoa powder. It is most preferred that the inclusions contain at least 35% cocoa powder, and more preferably at least 50% cocoa powder.

The inclusions optionally comprise one or more flavourings. Suitable flavourings include, but are not limited to fruit, nut, and vanilla flavourings, fruit powder, vanilla, herb flavourings, caramel and caramel flavourings. Those skilled in the art are familiar with numerous flavourings that can be selected for use in this invention. The flavourings may be added in a solid form or in a liquid form.

The listing or discussion of an apparently prior-published document in this specification should not necessarily be taken as an acknowledgement that the document is part of the state of the art or is common general knowledge.

The invention will now be described, by way of non-limiting example only, with reference to the accompanying drawings, which depict schematically processes according to the invention.

FIG. 1 shows a schematic illustration of a process for producing extruded inclusions according to the present invention. FIG. 1 shows a number of optional as well as essential steps.

FIG. 1 shows an overall process (10) for the production of finished packaged inclusions made by an extrusion process. The first stage (20) is the blending of certain ingredients prior to extrusion. The key components are sugar, preferably in the form of a powder having a relatively small particle size (average sieve size of 0.45 to 0.9 mm), and cocoa solids. A preferred form of sugar is icing sugar. However, other forms of sugar may be used. The sugar is mixed with cocoa solids in the form of cocoa powder and/or cocoa cake. Other optional ingredients may be added at this stage.

The combined sugar and cocoa solids (i.e. cocoa powder and/or cocoa cake) may then be transferred to an extruder for the extrusion step (40), or may undergo an optional preconditioning step (30) prior to extrusion. The preconditioning step involves heating and/or agitating the mixture of sugar and cocoa solids. Preferably, the mixture is both agitated and heated for a certain length of time. The mixture may be heated to a temperature of from about 30° C. to about 95° C., preferably about 90° C. A convenient method of agitation is to knead the mixture in a known kneading apparatus. The preconditioning step preferably takes from about 0 to about 300 seconds, more preferably about 220 seconds. The preconditioning step can be preformed in a continuous or discontinuous manner, using devices such as a ribbon blender, plough blender, screw blender or other such means known to the skilled person. The preconditioning step may help to improve the colour and/or taste of the mixture. After the preconditioning step (30), the mixture is then passed to an extruder for the extrusion step (40).

The extrusion step may be carried out in a suitable apparatus known to the skilled person, such as a multisection twin screw extruder. Within such an apparatus, twin helical screws heat, knead and compress the mixture as it is passed along the barrel of the extruder. With a multisection extruder, it is possible to control the temperature, pressure and screw rotation speed within each section to achieve optimum results. Suitable extruder screws in the process of the invention include the Clextral BC 82 twin rotating screw extruder available from Clextral SAS. Another suitable extruder is a Bühler type BCTG 62 available from Bühler AG extruder.

The temperature within the extruder may be from about 10° C. to about 250° C., preferably about 140° C. with pressures of from about 0 to about 50 bar. Preferably, the temperature of the mixture within the extruder is about 140° C. Good results have been found with screw speeds of from about 100 to about 620 rpm, and more preferably at about 500 rpm.

The extruder is fitted with a die-head of having a specific cross-sectional shape. The cross-section of the die-head may be rectangular, square, circular, oval or annular, amongst other possible shapes.

After being extruded through the die-head, the resulting extrudate may be shaped into discrete products by being broken up and/or cut into discrete pieces. Preferably, this is done by cutting the extruded product into smaller pieces. The extruded product may be formed into bars, pellets, nuggets, flakes, ribbons, sticks, balls, pillows, curls, granules and chunks amongst other possible shaped products. This is carried out in the optional shaping and cutting step (50).

The extrudate may be cut up into discrete individual products by a revolving cutter located in the exit of the extruder. The cutter may rotate at a speed from about 0 to about 5,000 rpm. FIG. 2 is a photograph showing the various forms in which the inclusions of the invention may take, including sticks, pillows, flakes, curls, granules, pellets, and nuggets.

Surface patterns may be provided on the extrudate by techniques such as stamping, engraving or moulding. For example, shapes such as logos or trade marks or other surface protrusions or indentations may be provided.

The extrudate may be formed into ribbons (or sheets) and shaped articles subsequently produced from the ribbons (or sheets), for example by stamping. Articles such as relatively flat spoons of the type shown in FIGS. 7, 8 and 9 may be produced in this way.

The size of the inclusions can vary, depending upon the extrusion conditions and the desired application. For example, the inclusions made relatively small for example in the form of granules, or may be relatively long, for example in the form of ribbons or sticks. The shape and size of the inclusions is determined by the processing characteristics, including the size and shape of the die, the temperature and pressure within the extruder, and the length of the extrudate before cutting (which corresponds to the speed of extrusion and the frequency of cutting). Preferably, the inclusions are sized from about 1 mm to about 10 mm across their greatest dimension. Inclusions having a size (diameter) of about 3 to 4 mm are most preferred, although the appropriate size depends on the final application. The density of the inclusions is preferably from 100 to 500 grams per litre, preferably about 350 grams per litre. The number of pieces of inclusions per 100 grams if preferably from 1 to 25,000, preferably 2,000.

The product formed by the extrusion step, optionally cut into smaller pieces, may then undergo a drying step (60) to reduce the overall level of moisture. Preferably, the product is dried until it has a moisture level of less than about 5% water, more preferably from about 1 to 3% water. Methods of drying such products are well known to the person skilled in the art and may involve, for example, exposing the product to a flow of heated gas, such as hot air, infrared radiation and/or exposure to a pressure less than atmospheric pressure, for example in a vacuum oven.

After the optional drying step, the product may undergo packaging (70). This may involve packaging individual pieces of the cocoa or chocolate flake product, or packaging a plurality of cocoa or chocolate flake products together.

The cocoa inclusions of the invention may be used in their own right as an edible product. For example, stick-like inclusions may be provided for consumption with a beverage. For example, a stick-like inclusion could be served with a hot beverage such as a coffee. The stick-like inclusion could be used to stir the beverage to impart a cocoa taste, and may also be consumed. For this application, a stick may for example have a length of around 6.5 centimetres, a mass of around 4 grams and a diameter of around 0.75 centimetres. Another example of the inclusion being used as a food stuff in its own right would be in the form of tubular or straw-like inclusion. This could for example be used to stir a beverage and also be used as a straw to drink the beverage. This is particularly suitable for use with milk. In addition, to imparting a cocoa taste to the milk or other beverage, the tubular inclusion could be consumed.

A further example of cocoa inclusions of the invention that may be used in their own right as an edible product is a spoon or spoon-like product. Examples of these products are shown in FIGS. 7, 8 and 9. For example, a relatively flat spoon of the type used to eat desserts such as ice cream from a container may be provided. The spoon may be consumed after it has been used, enhancing the consumer's enjoyment of the product and avoiding litter.

Therefore, the invention also contemplates a shaped article formed from (and preferably consisting of or consisting essentially of) a mixture produced by a method comprising extruding a mixture of at least 20% sugar with at least 25% cocoa powder or at least 10% cocoa cake or at least 10% of a combination of cocoa powder and cocoa cake, according to the invention.

In addition to be being used as food products in their own right, the inclusions may be incorporated into other food products. In a preferred aspect, the inclusions are added to the food product in an amount of up to 15%, preferably up to 10%.

For example, the inclusions may be incorporated into other food products such as beverages, ice-cream, bakery goods such as breads, brioche and biscuits, dairy products such as desserts, breakfast cereals, confectionary, spreadable products, cereal bars and animal products. Preferred beverages include coffee containing drinks such as a cappuccino, milk-containing drinks such as milk shakes, smoothies and vending machine beverages.

Advantages of the inclusions of the invention, particularly low fat products, is that they are bake-stable and retain a solid texture or crunchiness during storage. This is particularly important in terms of handling and storing the inclusions and any product that contains the inclusions. Increases in ambient temperature during handling or storage of chocolate based products can have unwanted melting effects which spoil desired characteristics of those products. The inclusions of the invention have the advantages of being melt-stable and storage-stable over a wider range of conditions and temperatures. The inclusions can be made to be crunchy, and can keep the desired crunchy texture in use. The inclusions are also bakestable, allowing their use in a wide variety of cooked goods, including bakery products such as cakes, muffins, biscuits, cookies and brioche, for example.

Examples of the use of the inclusions in confectionary may be as a replacement for cocoa nibs in products and further processes. Also, the inclusions products may be coated or panned with chocolate or other coatings to form confectionary products, such as dragées. They may also be used to form a crunchy product which may be used in applications similar to Pailleté Feuilletine™, a product available from the Barry Callebaut group of companies which is often used as an inclusion in other confectionary products, such as chocolates and pastries.

The inclusions of the invention may be used in a variety of sweet and savoury products, such as snacks including salty, spicy and sweetened snacks. In addition to being formulated to preserve their crunchiness during storage, the extruded products may be formulated and incorporated into other products such as ice cream in order to partially or completely dissolve over time.

The cocoa or chocolate flake products of the invention may also be incorporated into a number of spreadable products, such as jams, marmalades, honeys and other sweet spreadable products such as spreads containing nuts, such as hazelnuts, and chocolate containing spreads. The cocoa or chocolate flake products may also be incorporated into animal foods, particularly pet food. As some animals, such as dogs, are relatively intolerant of compounds in chocolate, particularly theobromine, these chocolate flake or cocoa products are preferably made using cocoa powder and/or cocoa cake having reduced levels of theobromine.

The chocolate flake or cocoa products may be made using cocoa powder and/or cocoa cake having relatively high levels of polyphenols. The person skilled in the art is aware of how to prepare such cocoa solids, which generally involves processing cocoa pods to extract the cocoa solids whilst retaining much of the original polyphenol compounds present in the bean. This may involve harvesting the seed or bean at an early stage, using non-fermented or underfermented beans, and using minimal or controlled levels of heat during subsequent processing steps.

The inclusions are also suitable for long shelf-life applications including dairy products, pastries and frozen desserts due to their low content of thermo resistant flora (which may be below 50 cfu/g of thermophylic or mesophylic flora). The low level of these bacteria is believed to be due to the relatively high temperatures and/or pressures encountered during the extrusion process.

In the prior art, the manufacture of some chocolate inclusions involved a number of different steps which were carefully performed using the various components used in making chocolate. The chocolate components include cocoa powder, milk powder, cocoa butter, cocoa liquor, lecithin and sugar. Typically, the sugar starting material does not have a sufficiently small particle size for its direct use in the production of chocolate. It is therefore passed through a grinder to sufficiently reduce the particle size for use in the production of chocolate. The chocolate components are mixed together and refined. After the refining step the mixture undergoes conching. This process raises the temperature of the mixture and helps to develop the chocolate flavour.

After conching the mixture is liquefied and then undergoes a tempering process. Tempering involves the controlled heating and cooling of the mixture to selectively cause the crystallisation of the cocoa butter in a preferred form (known as crystal form V).

After tempering, the mixture can then be poured into moulds followed by cooling to solidify the chocolate mass. Once sufficiently cooled, the shaped chocolate products may be removed for packaging or further processing steps.

The conching, liquefying, tempering, moulding and cooling steps are relatively time and energy intensive and place restrictions on the rate at which chocolate products can be made. Furthermore, the relative amounts of the chocolate components have profound effects on the properties of the mixture during its transformation into the final chocolate product. For example, the level of cocoa butter or other fats in the mixture affect the viscosity during the liquid steps. A relatively large amount of cocoa butter reduces the viscosity of such a liquid mixture, whereas a low level of cocoa butter can increase the viscosity to such high levels that technical problems are encountered. In particular, it can be difficult to handle a molten chocolate mixture having a low fat content because its high viscosity can cause problems with pumping.

The present invention relates to the extrusion of a mixture of sugar with cocoa powder and/or cocoa cake. Additional components may be incorporated into the mixture before the product is extruded. However, in a preferred aspect of the invention, the mixture consists essentially of sugar with cocoa powder and/or cocoa cake. In other words, the mixture consists essentially of sugar and cocoa powder; sugar and cocoa cake; or sugar and cocoa powder and cocoa cake.

In another preferred aspect of the invention, the mixture consists essentially of sugar and water, with cocoa powder and/or cocoa cake. In other words, the mixture consists essentially of sugar and water and cocoa powder; sugar and water and cocoa cake; or sugar and water and cocoa powder and cocoa cake.

The terms “extrusion” and “extruder” are well known to the person skilled in the art of preparing food products. Extrusion can be performed in a batch-wise or a continuous manner. The present invention is preferably performed in a continuous manner, with ingredients being added to the extruder during extrusion. Extrusion involves submitting the ingredients to pressure and preferably increased temperatures, with the mixture preferably being passed through a die. A preferred form of extruder is a screw extruder, in which a helical screw rotates within a barrel, causing mixing, compression and heating of the mixture. As is known to a person skilled in the art, various forms of extruders are commercially available. Such industrial extruders allow control and measurement of various aspects of the extrusion process, such as the temperature of the mixture within the barrel, the pressure of the mixture within the barrel and the speed of rotation of the screw. A preferred extruder is a twin screw extruder. Another preferred aspect is the use of a multi-section extruder which allows for control of operating parameters within each of the sections independently. A three section extruder is most preferred.

The process according to the invention does not require the steps of conching, liquefying, tempering, moulding and cooling in order to produce shaped products. This saves substantial amounts of energy during the manufacturing process and also time and space at the manufacturing site. The process simplifies the preparation and handling of the components and the resulting product and can increase throughput. By utilising a powder mixture, it is possible to lower the fat content without causing handling problems that may arise with a liquefied mixture at this fat content.

In general, the smoothness of the mouthfeel of cocoa-containing inclusions or chocolate flakes may be improved by reducing the particle size of the cocoa. A relatively large particle size is suitable for many applications, for example in baking, cooking or inclusion in other food products such as breakfast cereals where the cocoa may be eaten along with other foodstuffs which do not have a smooth mouthfeel. For example, this may include the use of inclusions in cookies. When the inclusion is to be eaten on its own, it may be beneficial to reduce the particle size of the cocoa further in order to improve the smooth mouthfeel.

The term “cocoa-containing inclusion”, “cocoa inclusion”, “chocolate flake inclusion” or “inclusion” is meant to refer to the product resulting from the method of the invention. The term “chocolate” has a variety of legal definitions, which vary from country to country. For example, a product that may be described as chocolate in one country may not fall within the legal definition of chocolate in another country. Depending upon the composition of fat content of the cocoa containing inclusion of the present invention, it may or may not be labelled as chocolate in a particular country, depending upon their laws and regulations.

The following non-limiting examples illustrate the invention and do not limit its scope in any way. In the examples and throughout this specification, all percentages, parts and ratios are by weight unless indicated otherwise.

The following are suitable compositions for use in an extrusion step to produce cocoa inclusions or chocolate flake inclusions in accordance with the invention.

The compositions are fed into a Clextral BC82 twin rotating screw extruder at a flow rate of 110 kg/h with a process temperature of 140° C. in the three sections of the extruder, the rotation speed of the screw is 350 rpm.

### Composition 1

50% icing sugar
50% natural defatted 10/12 cocoa powder

### Composition 2

2.5% water
48.75% icing sugar
48.75% natural defatted 10/12 cocoa powder

### Composition 3

50% icing sugar
50% natural defatted cocoa cake

### Composition 4

50% icing sugar
50% natural defatted cocoa cake (in the form of expeller flake)

### Composition 5

50% icing sugar 25% natural defatted cocoa powder 25% natural defatted cocoa cake

### Composition 6

50% icing sugar 50% alkalized defatted cocoa powder

### Composition 7

2.5% water 48.75% icing sugar 48.75% alkalized defatted cocoa cake

### Composition 8

50% icing sugar
50% alkalized defatted cocoa cake

### Composition 9

50% icing sugar
50% alkalized defatted cocoa cake (in the form of expeller flake)

### Composition 10

50% icing sugar
25% alkalized defatted cocoa powder
25% alkalized defatted cocoa cake

### Composition 11

40% icing sugar
60% natural cocoa powder

### Composition 12

40% icing sugar
60% natural cocoa cake

### Composition 13

40% icing sugar
30% natural cocoa powder
30% natural cocoa cake

### Composition 14

40% icing sugar
60% alkalized cocoa powder

### Composition 15

40% icing sugar 60% alkalized cocoa cake

### Composition 16

40% icing sugar
30% alkalized cocoa powder
30% alkalized cocoa cake

### Composition 17

35% cocoa powder
37% icing sugar
20% whole milk powder
8% skimmed milk powder

### Composition 18

25% cocoa powder
47% icing sugar
20% whole milk powder
8% skimmed milk powder

The inclusions of the invention may be used in a wide range of applications, as exemplified below:

### Biscuit

### Recipe

| Ingredients | % Ingr |
|---|---|
| Flour | 44.1 |
| Salt | 0.3 |
| Sucrose | 19.9 |
| Eggs | 11.0 |
| Butter | 17.7 |
| Cocoa inclusions 3 mm diameter | 7.1 |
| Total | 100.0 |

### Preparation Method

Blend flour and butter.
Incorporate Icing sugar, cocoa inclusions and salt.
Blend the batter with eggs.
Bake at 170° C. for 15 minutes.

Biscuits made according to this method are shown in FIG. 3.

### Brioche

### Recipe

| Ingredients | % Ingr |
|---|---|
| Flour | 38.6 |
| milk | 7.0 |
| Salt | 0.8 |
| Icing sugar | 11.6 |
| Whole egg | 15.5 |
| Butter | 19.3 |
| Cocoa inclusions 5/6/7 mm diameter | 8.0 |
| Yeast | 0.8 |
| Water | 5.6 |
| Total | 100.0 |

### Preparation Method

Mix the flour and yeast.
In the blender add warm water and milk.
Incorporate eggs, sugar and salt and then blend at speed 2 for 10 minutes.
Add the melted butter and mix again for 10 minutes then add the inclusions.
Stand at room temperature (25° C.) for 50 minutes.
Knead and separate in 6 parts in moulds.
Let stand at room temperature (25° C.) for 70 minutes.
Preheat the oven at 180° C. and bake at 180° C. for during 35 minutes.
Demould when baked.

Brioche made according to this method is shown in FIG. 4.

### Spread

### Recipe

| Ingredients | % Ingr |
|---|---|
| skimmed milk powder | 11.0 |
| Sucrose | 57.7 |
| Hazelnut paste | 12.0 |
| Lecithin | 0.3 |
| Cocoa inclusions 1 mm diameter | 6.0 |
| Fat | 13.0 |
| Total | 100.0 |

### Preparation Method

Blend all the ingredients together.
Grind the mixture through a 5 roll mill.
Send the mixture to a conch for 1 hour at 40° C.
Add the cocoa inclusions and blend.

### Cereal Bars

### Recipe

| Ingredients | % Ingr |
|---|---|
| Cereal | 30.0 |
| Syrup | 40.0 |
| Cocoa inclusions 3 mm diameter | 20.0 |
| Chocolate | 10.0 |
| Total | 100.0 |

### Preparation Method

Prepare the syrup and keep it hot at 50° C.
Blend all the dry ingredients with the syrup.
Cool down the bar.
Dip the bar to cover the underside in the chocolate.
Cereal bars made according to this method are shown in FIG. 5.
Soft Ice cream

### Recipe

| Ingredients | % Ingr |
|---|---|
| Skimmed milk powder | 12.0 |
| sucrose | 17.5 |
| butter | 5.5 |
| Panned cocoa inclusions | 2.5 |
| Whipping agent* | 1.8 |
| water | 60.7 |
| Total | 100.0 |

*Hyfoama range

### Preparation Method

Mix the water and the milk powder.
Add a most of the sugar.
Add the melted butter.
Add the mix of remaining sugar and Hyfoama whipping agent.
Cool as fast as possible before ageing during at least 3 hours.
Add the panned inclusions.
Freeze between 6 and 7 minutes.

### Chocolate

### Recipe

Add 7% of cocoa inclusions (diameter 4 mm) in a white chocolate before moulding (other chocolates, such as dark or milk, may be used).
A bar of chocolate made according to this method is shown in FIG. 6.

### Measurement of the Levels of Bacteria

The presence of thermo resistant spores (such as Mesophylic or Thermophylic spores) may be determined according to the following procedure.

The procedure may be may be used for finished products, raw materials and environmental samples.

### Principle

The sample is heat treated at 100° C. and then incubated at 55° C. in a non-selective media in order to isolate thermo resistant thermophylic spores only.

### Media and Dilution Fluid

Dilution fluid: Tryptone soya broth
Medium: Tryptone soya agar

The tryptone soya broth may be prepared by dissolving the dehydrated tryptone soya in water by boiling. Quantities of 90 ml are sterilized at 121° C.±1° C. for 15 minutes. The broth is cooled to 45° C.±1° C. before use.

The tryptone soya agar may be prepared by dissolving 80 g of tryptone soya in 1000 ml of distilled water and bringing to the boil. Another 1000 ml of distilled water is warmed to 90° C. The two quantities are mixed until the tryptone soya is dissolved. The mixture is then placed into bottles and sterilized at 121° C.±1° C. for 15 minutes and then cooled to 45° C.±1° C. before use. The medium is used on the same day as it is prepared.

### Method

(i) Add 10 g±0.5 g of sample to 90 ml of tryptone soya broth and mix well.
(ii) Transfer 10 ml into each of 2 tubes.
(iii) Heat for 30 minutes at 100° C. in a boiling water bath. The level of water in the bath should be above the level of the liquid in the tubes. The timing should begin when the temperature in the tubes reaches 100° C. This should take no longer than 5 minutes.
(iv) Cool the tubes under cold running tap water (to promote germination).
(v) Add 2 ml of the solution from each tube to each of five 14 cm diameter petri dishes.
(vi) Add 50-75 ml of tryptone soya agar, mix thoroughly and allow 30 minutes to set.
(vii) Invert and incubate for 48±4 hours at 55° C.±1° C. To keep the atmosphere in the incubator moist, place two beakers filled with water with the plates. For thermo resistant mesophylic spores the plates can be incubated at 35° C.±7° C. for 48±4 hours instead of 55° C.
(viii) Count the colonies and express as thermo resistant spores per gram.

1.-37. (canceled)

38. An extruded inclusion comprising at least 20% sugar with at least 25% cocoa powder or at least 10% cocoa cake or at least 10% of a combination of cocoa powder and cocoa cake.

39. An inclusion according to claim 38 which contains less than about 13% fat.

40. An inclusion according to claim 38 which contains less than about 10% fat.

41. An inclusion according to claim 38 which contains less than about 6% fat.

42. An inclusion according to claim 38 wherein the sugar is icing sugar.

43. An inclusion according to claim 38 wherein the cocoa powder and/or cocoa cake contains natural cocoa solids.

44. An inclusion according to claim 38 wherein the cocoa powder and/or cocoa cake contains alkalized cocoa solids.

45. An inclusion according to claim 38 which comprises at least 35% cocoa powder, preferably at least 40% cocoa powder, more preferably at least 50% cocoa powder, more preferably at least 60% cocoa powder.

46. An inclusion according to claim 38 which comprises at least 20% cocoa cake, more preferably at least 35% cocoa cake, more preferably at least 40% cocoa cake, more preferably at least 50% cocoa cake, more preferably at least 60% cocoa cake.

47. An inclusion according to claim 38 wherein the cocoa powder and/or cocoa cake contains from about 0% to about 56% fat.

48. An inclusion according to claim 38 wherein the cocoa powder and/or cocoa cake contains about 21% fat.

49. An inclusion according to claim 38 wherein the cocoa powder and/or cocoa cake contains about 11% fat.

50. An inclusion according to claim 38 which contains less than about 5% water.

51. An inclusion according to claim 38 which further comprises at least one component selected from the ground consisting of milk powder, cocoa butter, non-cocoa butter fats, emulsifiers, flavourings and colouring agents

52. An inclusion according to claim 38 which consists essentially of sugar with cocoa powder and/or cocoa cake.

53. A food product comprising an inclusion as defined in claim 38.

54. A food product according to claim 53 which is selected from the group consisting of beverages, breakfast cereals, ice cream, dairy products, baked products, desserts, cereal bars, animal foods, confectionary and spreadable food products.

55.-57. (canceled)
